(19) United States
(12) Patent Application Publication
(10) Pub. No.: US 2016/0194553 A1
(43) Pub. Date: Jul. 7, 2016

(54) Well Treatment Solid Chemical

(71) Applicant: Energy & Environmental Services, Inc., Oklahoma City, OK (US)

(72) Inventor: Melvin B. Smith, Oklahoma City, OK (US)

(21) Appl. No.: 15/068,195

(22) Filed: Mar. 11, 2016

Related U.S. Application Data
(63) Continuation of application No. 14/239,056, filed on Feb. 14, 2014, now abandoned.

(51) Int. Cl. C09K 8/70; C09K 8/80; E21B 43/24; E21B 43/16; E21B 37/06

(52) U.S. Cl. CPC C09K 8/70; E21B 43/16; E21B 37/06; E21B 43/24; C09K 8/80; C09K 2208/24

(57) ABSTRACT

A solid chemical delivery system for delivering chemicals to an underground formation. The solid chemical is formed bv dehydrating a precipitated silica matrix. Well chemicals are then introduced to the silica and form a tablet or pelletized chemical. The pelletized solid chemical is then delivered to the underground formation through the well bore with a proppant and well treatment fluid. This allows the well treatment chemicals to be released over time.

### CROSS REFERENCE TO RELATED APPLICATION

This application is a continuation of U.S. patent application Ser. No. 14/239,056 filed Feb. 14, 2014, which is a 371 of PCT/US12/61753, filed on Oct. 24, 2012, the entire contents of which are incorporated herein by reference.

### FIELD

The present invention relates to well treatment and delivery methods for well treatment chemicals.

### SUMMARY

The invention is directed to a method for treating a formation accessible through a wellbore. The method comprises the steps of providing an anhydrous, or dried, amorphous silica matrix formed to carry a well treatment chemical within the matrix to forma solid chemical and pumping the solid chemical, a proppant, and a well treatment fluid into the wellbore. The solid chemical is positioned within a fracture created by the well treatment fluid and provides a metered release of the well treatment chemical therefrom.

In another embodiment the invention is directed to a well treatment device. The device comprises an anhydrous silica matrix and a well treatment chemical held within the silica matrix to form a solid chemical. The chemical is releasable from the silica matrix within a wellbore.

In another embodiment, the invention is directed to a device for delivering a well treatment chemical into a wellbore. The chemical is prepared by a process. The process comprises providing a silica matrix, heating the silica matrix to drive off moisture contained therein to form an anhydrous silica, and mixing the anhydrous silica with a well treatment chemical to absorb the well treatment chemical with the silica matrix to form a solid chemical.

### BRIEF DESCRIPTION OF THE DRAWINGS

FIG. 1 is a diagrammatic representation of an injection well and material delivery system for delivery of the well treatment chemical created in the process of FIG. 2.

FIG. 2 is a flow chart demonstrating a process of creating the solid well treatment chemical of the present invention.

FIG. 3 is a diagrammatic representation of a solar cell heating element for use with the present invention.

FIG. 4 is a diagrammatic representation of a process for coating the present invention.

### DETAILED DESCRIPTION OF THE DRAWINGS

A hydraulic fracture is formed by pumping the well treatment fluid into the wellbore at a rate sufficient to increase pressure downhole to exceed that of the fracture gradient of the rock. The rock cracks and the fracture fluid enter the rock, extending the crack. To keep this fracture open after the injection stops, a solid proppant, commonly sand, is added to the fluid. The propped fracture is permeable enough to allow the flow of formation fluids to the well. Formation fluids include gas, oil, salt water, fresh water and fluids introduced to the formation during completion of the well during fracturing.

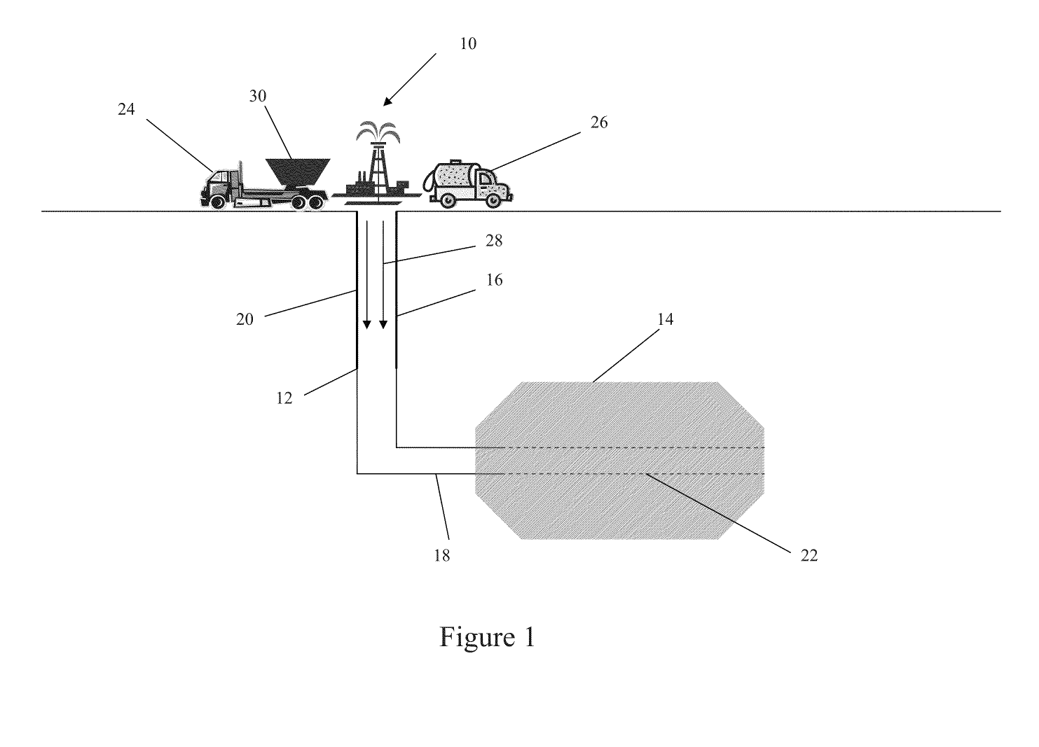

Turning to the figures in general and FIG. 1 specifically, shown therein is an injection well 10 for use with the claimed invention. The injection well comprises a well shaft 12 within a subterranean formation 14. The well shaft 12 comprises a vertical shaft 16 and may comprise a horizontal section 18. Further, the well shaft 12 comprises a well casing 20 that is adapted to seal a portion of the well shaft 12 such that fluids may not travel into or out of the subterranean formation 14 proximate the well casing. The well shaft 12 further comprises a production portion 22 that does not have a well casing 20 such that well treatment chemicals such as fracturing chemicals may be delivered to the subterranean formation 14 and desired products such as oil, natural gas, and natural gas liquids are removed from the subterranean formation.

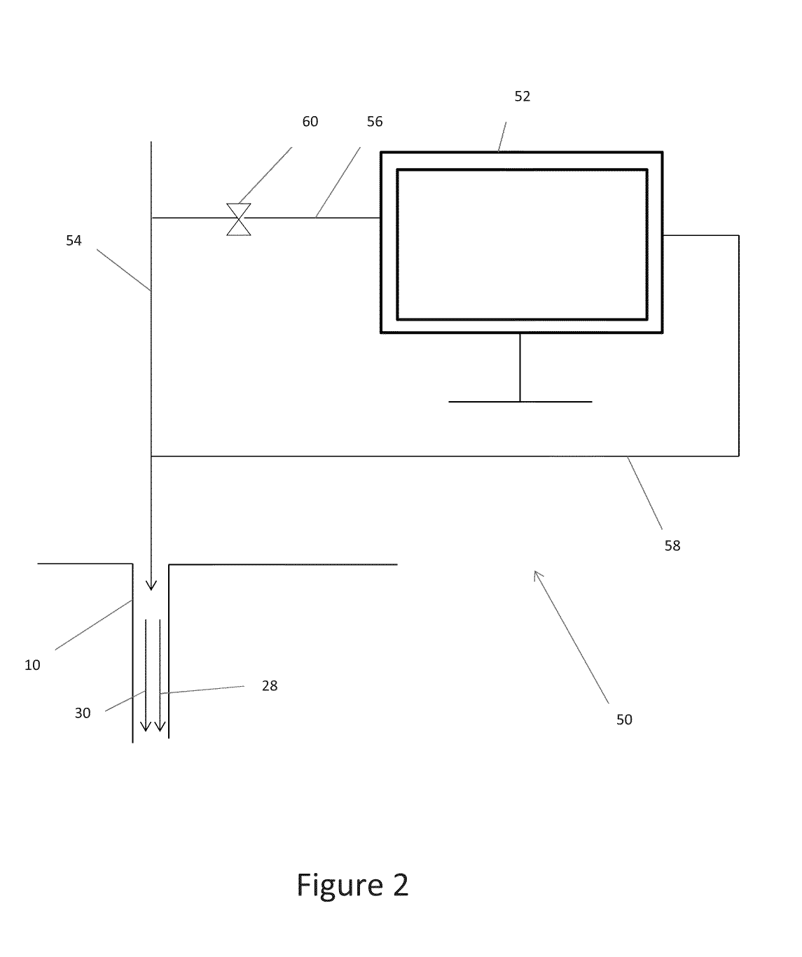

A material delivery system 24 is provided at ground level proximate the injection well 10. The material delivery system 24 delivers products into the well shaft 12 for enhancement of the drilling process. The material delivery system is preferably used in conjunction with a fracturing system 26 for delivery of ground level well treatment fluid 28 into the well shaft 12. The well treatment fluid 28, when delivered to the subterranean formation 14, causes hydraulic fracture and allows delivery of proppant and well treatment chemicals. The material delivery system 24 comprises a well treatment product 30 which is created through the process of FIG. 2.

With reference now to FIG. 2, the material delivery system 24 may comprise a heat treating system 50 for improving the treatment quality of the well treatment product 30. A solar panel 52 is provided to connect to a flow line 54 in communication with the injection well 10. Conventional solar panels 52 of many sizes may be utilized depending on the heat capacity needed for the particular heat treating system 50. The solar panel 52 is connected to the flow line 54 by an inlet pipe 56 and an outlet pipe 58. Well treatment product 30 and well treatment fluid 28 are fed into the injection well 10 from the flow line 54. Prior to entering the injection well 10, a portion of the well treatment fluid 28 is segregated into the inlet pipe 56, heated by the solar panel 52 and returned to the flow line 54 through the outlet pipe 58. One skilled in the art will appreciate that a valve 60 may be provided on the inlet pipe 56 to adjust the amount of well treatment fluid 28 and well treatment product 30 being heated. Therefore, the temperature of well treatment fluid 28 and well treatment product 30 entering the injection well 10 can be modulated or stabilized due to changes in environmental conditions and the heating capacity of the solar panel 52. Further, the heat treating system 50 may be mobile and the heat provided to the well treatment fluid 28 may depend upon the heaviness of oil located in the subterranean formation 14 (FIG. 1).

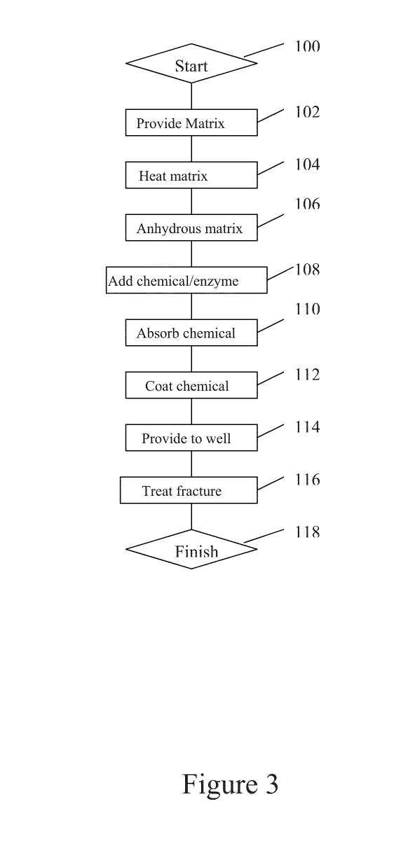

With reference now to FIG. 3, a method for creating an enhanced well treatment product 30 for delivery to the subterranean formation 22 by the material delivery system 24 (FIG. 1) is shown. As one skilled in the art will appreciate, liquid products have associated weaknesses, such as immediate delivery to a treatment location and an inability to control the delivery of chemical product over time. The method shown in FIG. 3 provides a process for creating a well treatment product 30 in a solid matrix form. The method starts at 100. A silica matrix is provided at 102. The silica matrix is heated at 104 to drive off moisture contained therein. When the moisture is removed, an anhydrous silica is left at 106. The anhydrous silica is mixed with a well treatment chemical and enzyme at 108 and the well treatment chemical is absorbed within the anhydrous silica matrix at 110 to form a solid chemical. The solid chemical may then be coated with a resinous material at 112. The well treatment fluid 28 may be heated at 113. The heating of the well treatment fluid 28 may take place before or after the solid chemical is added to the well treatment fluid. The solid chemical, a proppant, and the well treatment fluid 28 are provided to the wellbore at 114. This causes the solid chemical to be positioned within the subterranean formation 14 and more particularly a fracture therein created by the well treatment fluid, providing a metered release of well treatment chemical at 116. The method ends at 118.

The solid chemical may comprise a silica spheroid, a silica pellet, or other shape. Preferably, the solid chemical silica matrix is a porous anhydrous silica spheroid. As used herein, “well treatment product” 30 comprises an advantageous chemical such as a scale inhibitor, corrosion inhibitor, paraffin product, H₂S scavenger, or foamer. Additionally, the product 30 could be an emulsifier, non-emulsifier, wetting agent, sludge preventive, retarder, suspension agent, anti-swelling agent, or stimulation additive.

The solid chemical created by this method preferably utilizes precipitated amorphous silica. This precipitated amorphous silica is significantly more porous than other known matrices for carrying material, such as diatomaceous earth and others. Preferably, the porosity of the silica matrix exceeds 50 percent by volume. More preferably, the porosity may exceed 70 percent by volume. Such high porosity allows more well treatment chemical per volume of silica. Likewise, the time release of the solid chemical may be extended due to the increased porosity.

Enzymes may be packaged with the solid chemical well treatment product 30 as a part of the solid chemical silica matrix created at step 102. Enzymes used for these purposes may comprise lipases, proteases and amylases. Enzymes, when used together in the solid chemical treatment matrix with the well treatment product 30, promote more efficient delivery of well treatment product to the subterranean formation 14. Heating the well treatment product 30 through providing heated well treatment fluid 28 alone or in conjunction with an enzyme may improve the ability of the well treatment product to enter the fracture of the subterranean formation 14.

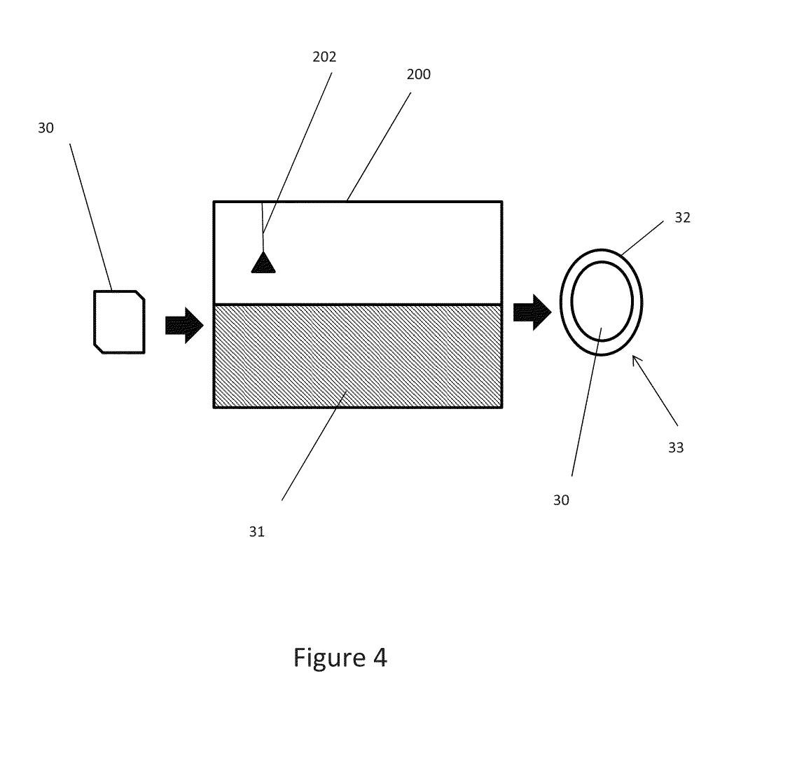

100171 With reference to FIG. 4, a coating 31 may be provided on an outer surface of the solid chemical well treatment product 30. The coating 31 may comprise a polyvinylidene chloride (“PVDC”) resin such as SARAN™. Methods for coating solids with these particular coating substances may be found in U.S. Pat. No. 3,264,131, issued to Nagel, and U.S. Patent No. 5,373,901, issued to Norman, et al. In both references, a fluidized bed 200 is utilized to apply the coating to a product. A spray coating system 202 may also be utilized. In the present method, the well treatment product 30 is coated with a coating 31 prior to the step of providing the coated solid chemical 33 to the wellbore at 114 (FIG. 2).

The encapsulating material 32 making up the coating 31 may comprise a partially hydrolyzed acrylic, preferably in an aqueous based form which is cross-linked either with an aziridine prepolymer or a carbodiimide. The encapsulating material 31 is preferably admixed with a particulate micron-sized material such as silica dust of a size range from 1 micron to 15 microns. Preferably, the silica comprises from 0%-60% by weight of the coating 32 solids. The encapsulating material 31, when applied to the well treatment chemical 30, may bias to the shape of the coated well treatment chemical 33 to a spheroid or ellipsoid.

The coating 32 thickness may be adjusted to provide time-delay of the release of the well treatment product 30. As one skilled in the art will appreciate, liquid products have associated weaknesses, such as immediate delivery to a treatment location and an inability to control the delivery of chemical product over time. Similarly, time-release matrices such as that previously invented by the applicant may provide a set time-release, but in mineral production applications, time-release on the order of years is desired. The coatings chosen, thicknesses of the coatings, porosity of coatings, solubility of the coatings, and the percentage of well treatment chemical 30 coated by said coatings will meter the release of well treatment chemical. Alternatively, various coatings could be used having differing properties to similarly meter the release of well treatment chemicals. Water-based coatings may be preferred, but are not required to perform the steps of the disclosed invention.

One skilled in the art can envision other potential combinations of the principles disclosed in the above embodiments. For example, the present invention may be utilized in remedial well clean-ups using a coil tubing unit, acid pump trucks, combo units, and bob tails employing the solid chemical.

What is claimed is:

1. A method for delivering a liquid chemical agent in a solid form, the method comprising:
providing an amorphous silica matrix formed to carry a well treatment chemical within the matrix to form a solid chemical wherein the amorphous silica matrix has a porosity exceeding 50 percent by volume;
providing an enzyme proximate the amorphous silica matrix; and
pumping the amorphous silica matrix, a proppant, nd a well treating fluid into the wellbore;
wherein the solid chemical is circulated within the well using the well treating fluid and provides a metered release of the well treatment chemical therefrom.

2. The method of claim 1 wherein the amorphous silica matrix comprises a silica spheroid.

3. The method of claim 1 wherein the amorphous silica matrix comprises a silica pellet.

4. The method of claim 1 further comprising coating the solid chemical with a resinous material.

5. The method of claim 1 wherein the well treatment chemical comprises at least one of the following selected from: scale inhibitors, corrosion inhibitors, paraffin products, H2S scavengers, foamers, demulsifiers, water conditioners, surfactants, polymer breakers.

6. The method of claim 1 wherein the enzyme comprises at least one of the following selected from: lipases, proteases and amylases.

7. The method of claim 1 wherein the silica matrix comprises a porous anhydrous silica spheroid.

8. The method of claim 1 further comprising providing a solar heat source.

9. The method of claim 8 further comprising:
diverting the well treating fluid into the solar heat source;
heating the diverted well treating fluid; and
providing the heated well treating fluid to the wellbore to circulate in the well.

10. A device for delivering a well treatment chemical into a wellbore prepared by a process comprising:
providing an amorphous precipitated silica matrix having a porosity greater than 50% by volume;
heating the precipitated silica matrix to drive off moisture contained therein; and
mixing the precipitated silica matrix with a well treatment chemical to absorb the well treatment chemical with the silica matrix to form a solid chemical.

11. The device of claim 10 wherein the amorphous precipitated silica comprises a silica spheroid.

12. The device of claim 10 wherein the amorphous precipitated silica comprises a silica pellet.

13. The device of claim 10 further comprising coating the solid chemical with a resinous material.

14. The device of claim 10 wherein the well treatment chemical comprises at least one of the following selected from: emulsifiers, inhibitors, non-emulsifiers, wetting agents, sludge preventives, retarders, suspension agents, anti-swelling agents, or stimulation additives.

15. The device of claim 10 wherein the silica matrix has a porosity of greater than 70 percent by volume.

16. The device of claim 10 wherein the enzyme comprises at least one of the following selected from: lipases, proteases and amylases.

17. A method for preparing a well treatment chemical for downhole treatment of a wellbore comprising:
carrying a well treatment fluid to a solar heat source; and
heating the well treatment fluid at the solar heat source;
providing a solid chemical into the well treatment fluid, wherein the solid chemical comprises an amorphous silica matrix and a well treatment chemical;
delivering the solid chemical and heated well treatment fluid to a fracture in the wellbore.

18. The method of claim 17 wherein the solid chemical is coated with a resinous material.

19. The method of claim 17 wherein the solid chemical is provided to the well treatment fluid prior to heating the well treatment fluid.

20. The method of claim 17 wherein the solid chemical is prepared by a process comprising:
providing a silica matrix;
heating the silica matrix to drive off moisture contained therein to form the anhydrous silica matrix;
applying an enzyme to the anhydrous silica matrix; and
mixing the anhydrous silica matrix with the well treatment chemical to absorb the well treatment chemical with the silica matrix to form a solid chemical.
